(19) United States
(12) Patent Application Publication
(10) Pub. No.: US 2011/0169792 A1
(43) Pub. Date: Jul. 14, 2011

(54) DISPLAY PANEL

(75) Inventors: Yukio Shimizu, Osaka-shi (JP); Gen Nagaoka, Osaka-shi (JP); Ichiro Umekawa, Osaka-shi (JP); Motoji Shiota, Osaka-shi (JP); Yasuhiro Hida, Osaka-shi (JP)

(73) Assignee: SHARP KABUSHIKI KAISHA, Osaka-shi, Osaka (JP)

(21) Appl. No.: 13/119,967

(22) PCT Filed: Jun. 15, 2009
(86) PCT No.: PCT/JP2009/060881

§ 371 Date: Mar. 21, 2011

(30) Foreign Application Priority Data
Sep. 29, 2008 (JP) 2008-249526

(51) Int. Cl. G06F 3/038; G09G 3/36

(52) U.S. Cl. 345/204; 345/87

(57) ABSTRACT

The present invention provides a display panel in which, without providing connection terminals, the number of which corresponds to the number of test terminals of a liquid crystal panel, on a circuit board such as an FPC board, miniaturization is obtained while reducing costs such as the mounting cost and material cost of the circuit board, and stable operation is performed. A liquid crystal panel (10) has a configuration in which jumper resistors (60a) to (60f) are provided in an overhanging portion (20a) of a glass substrate (20) to ground test terminals, which eliminates the need to ground the test terminals on an FPC board (50). Thus, wiring lines and connection terminals which are connected to the test terminals, respectively, and the numbers of which are equal to the number of the test terminals do not need to be provided on the FPC board (50), reducing the width of the FPC board (50). Thus, the material cost of the FPC board (50) is reduced, and a process performed when mounting the FPC board (50) on the glass substrate (20) is simplified, reducing mounting cost.

### TECHNICAL FIELD

The present invention relates to a display panel, and more particularly to a display panel including a circuit board for providing a video signal, a clock signal, etc., from an external source.

### BACKGROUND ART

FIG. 4 is a schematic plan view of a conventional liquid crystal panel used in a liquid crystal display device, before mounting an FPC board. FIG. 5 is a schematic plan view of the conventional liquid crystal panel after mounting an FPC board. As shown in FIGS. 4 and 5, a liquid crystal panel 910 includes two glass substrates 920 and 925 disposed to face each other; a Large Scale Integration Circuit (hereinafter, abbreviated as “LSI”) chip 940; liquid crystal panel test wiring lines 922; and test terminals 970. In addition, the liquid crystal panel 910 further includes a Flexible Printed Circuit (hereinafter, referred to as “FPC”) board 950.

A liquid crystal (not shown) is sealed in space sandwiched between the two glass substrates 920 and 925 by a sealing material (not shown). In addition, on an overhanging portion 920a of the glass substrate 920, the LSI chip 940 having a driver function required to drive the liquid crystal is mounted, and the liquid crystal panel test wiring lines 922 and the test terminals 970 are formed. The test terminals 970 are terminals for inputting and outputting electrical signals for a test of the liquid crystal panel 910. The liquid crystal panel test wiring lines 922 are wiring lines that connect the liquid crystal panel 910 to the test terminals 970.

In addition, the Flexible Printed Circuit (hereinafter, referred to as “FPC”) board 950 connected to a mainboard 990 of an electronic device is connected (secured). When a video signal is provided to the LSI chip 940 from the mainboard 990 through the FPC board 950, the LSI chip 940 drives a display portion 930 to display video.

Here, a test performed on the liquid crystal panel 910 using the test terminals 970 is normally performed before mounting the FPC board 950. Thus, after the test is done, the liquid crystal panel test wiring lines 922 and the test terminals 970 are unnecessary. However, if the test terminals 970 are left in an open state, then the test terminals 970 are placed in an undefined potential, floating state, which may cause abnormal operation of transistors, etc. (included in a test circuit) in the liquid crystal panel 910. Hence, in order to turn off the transistors or to avoid a floating state, terminals provided on the FPC board 950 are connected to ends of the liquid crystal panel test wiring lines 922 connected to the test terminals 970. Since the terminals provided on the FPC board 950 are connected to a GND (ground) wire or a VSS (low voltage) wire therewithin or on the mainboard 990 of the electronic device which is the connection source, the test terminals 970 can be connected to the GND (ground) wire or the VSS (low voltage) wire.

As such, the FPC board 950 requires such a number of dedicated terminals that is equal to the number of the test terminals 970, and moreover, multiple output terminals need to be provided on the LSI chip 940 according to the number of pixels of the display portion 930. Thus, the LSI chip 940 has a long and thin shape having long sides in a direction parallel to the display portion 930. Therefore, it is common that the width of the FPC board 950 which supplies a video signal, a clock signal, etc., to such an LSI chip 940 from the mainboard 990 is also comparable to or larger than the length of the long sides of the LSI chip 940.

In electronic devices having mounted thereon such a liquid crystal panel 910, such as mobile phones, for the purpose of further miniaturization, not only miniaturization of electronic components to be mounted, but also a reduction in the spacing between printed circuit boards having mounted thereon electronic components is considered.

Conventionally, in order to reduce the spacing between printed circuit boards, the FPC board 950 connected to the overhanging portion 920a of the glass substrate 920 is bent to reduce an apparent width W of the FPC board 950, thereby reserving free space around the FPC board 950, and printed circuit boards are placed in the free space. FIGS. 6A to 6C are diagrams showing a procedure for bending the FPC board 950 connected to the overhanging portion 920a of the glass substrate 920. First, as shown in FIG. 6A, the FPC board 950 having a width comparable to the length of the long sides of the LSI chip 940 is connected by thermocompression bonding to the overhanging portion 920a using an Anisotropic Conductive Film (hereinafter, referred to as “ACF”) (not shown). Then, as shown in FIG. 6B, the FPC board 950 is bent along the upper end of the glass substrate 920 and backward from the front on the paper. Then, as shown in FIG. 6C, those portions of the FPC board 950 protruding on the left and right of the glass substrate 920 are bent along the left and right ends of the glass substrate 920 and forward from the back on the paper, and the bent portions are fixed to the glass substrate 920 by a tape (not shown). By thus bending the FPC board 950 with a wide width to reduce the substantial width W of the FPC board 950, free space where printed circuit boards can be placed is reserved around the FPC board 950.

Japanese Patent Application Laid-Open No. 11-338376 discloses a liquid crystal display panel including a plurality of test TFTs; test control signal lines for controlling the test TFTs; and a test display signal line that transmits a test display signal. Furthermore, Japanese Patent Application Laid-Open No. 6-110072 discloses a liquid crystal display panel that allows an electrode probe to be used for narrow-pitch electrode terminals for a liquid crystal panel test. Furthermore, Japanese Patent Application Laid-Open No. 2000-321591 discloses a liquid crystal display panel in which electrode pads for mounting semiconductor chips are arranged in a staggered manner so that a probe does not contact the electrode pads.

### Prior Art Documents

### Patent Documents

[Patent Document 1] Japanese Patent Application Laid-Open No. 11-338376

[Patent Document 2] Japanese Patent Application Laid-Open No. 6-110072

[Patent Document 3] Japanese Patent Application Laid-Open No. 2000-321591

### SUMMARY OF THE INVENTION

### Problems to be Solved by the Invention

However, when the FPC board 950 with substantially the same width as the long sides of the LSI chip 940 is bent and wrapped around the glass substrate 920, and the wrapped FPC board 950 is fixed to the glass substrate 920 by a tape, a process of bending the FPC board 950 and fixing the FPC board 950 by a tape is required, causing a problem of an increase in mounting cost. In addition, since the FPC board 950 with substantially the same width as the long sides of the LSI chip 940 is used, there is another problem of an increase in costs such as the material cost and processing cost of the FPC board 950. Furthermore, since the wiring lines of the FPC board 950 to which electronic components 960 are connected are long, the influence of Electro Magnetic Interference (hereinafter, referred to as “EMI”) is received, causing another problem that the operation of the LSI chip 940 is likely to become unstable.

An object of the present invention is therefore to provide a display panel in which, without providing connection terminals, the number of which corresponds to the number of test terminals of a liquid crystal panel, on a circuit board such as an FPC board, miniaturization is achieved while reducing costs such as the above-described mounting cost and material cost of the circuit board, and stable operation is performed.

### Solutions to the Problems

According to a first aspect of the present invention, there is provided a display panel that displays an image based on a video signal provided from or to the outside, the display panel including:
an insulating substrate having an overhanging portion;
a display portion formed on the insulating substrate and displaying the image;
a test terminal for inputting or outputting a test signal provided from or to the outside to perform a test on the display portion;
a test wiring line connecting the test terminal to the display portion; a fixed-potential wiring line formed in the overhanging portion and providing a predetermined fixed potential;
a jumper component mounted on the overhanging portion and connecting the test wiring line to the fixed-potential wiring line;
an integrated circuit that drives the display portion based on the video signal; and
a circuit board having a wiring line layer and being connected to the insulating substrate by connecting the wiring line layer to a wiring line formed on the insulating substrate, the wiring line layer supplying a signal provided from an external source, to the integrated circuit.

According to a second aspect of the present invention, in the first aspect of the present invention, the jumper component may be connected to the test terminal at one end thereof, and may be connected to a connection terminal connected to the fixed-potential wiring line at an other end thereof.

According to a third aspect of the present invention, in the first aspect of the present invention, the jumper component may be a resistor with a near zero resistance.

According to a fourth aspect of the present invention, in the first aspect of the present invention, at least one fixed-potential wiring line may be connected to the circuit board or the integrated circuit, thereby providing the fixed potential.

According to a fifth aspect of the present invention, in the first aspect of the present invention, the test terminal, the test wiring line, and the fixed-potential wiring line may be formed of tantalum or aluminum.

According to a sixth aspect of the present invention, in the first aspect of the present invention, the display panel may further include at least one of electronic components mounted on the overhanging portion, the electronic components including a chip capacitor, a chip resistor, and a chip coil.

According to a seventh aspect of the present invention, there is provided a liquid crystal display device including a display panel according to the first aspect of the present invention.

### Effect of the Invention

According to the first aspect of the present invention, by a configuration in which a fixed-potential wiring line is formed in an overhanging portion and a jumper component that connects the fixed-potential wiring line to a test wiring line is mounted, a jumper component can be mounted after the test of a display portion. Thus, there is no need to provide wiring lines (connecting portions), the number of which corresponds to the number of test terminals, on a circuit board, e.g., an FPC board, to bring the test terminals to a fixed potential. Accordingly, a display panel can be provided that performs stable operation and achieves miniaturization while reducing costs such as the mounting cost (e.g., a cost required for a process of bending and fixing by a tape) and material cost (e.g., related to a reduction in the width of the circuit board) of the circuit board.

According to the second aspect of the present invention, since one end of the jumper component is connected to the test terminal, by a configuration in which the test terminal is allowed to also serve as a connection terminal, the number of terminals in the overhanging portion can be reduced, enabling to simplify the configuration.

According to the third aspect of the present invention, the jumper component is a resistor with a near zero resistance and thus can be easily acquired or manufactured. In addition, the potential of the test wiring line can be reliably allow to substantially coincide with the fixed potential of the fixed-potential wiring line.

According to the fourth aspect of the present invention, since at least one fixed-potential wiring line is connected to the integrated circuit, thereby providing the fixed potential, the fixed potential can be easily obtained and there is no need to form a fixed-potential wiring line such that the fixed-potential wiring line is routed to the circuit board in the overhanging portion, enabling to effectively use the space on the overhanging portion.

According to the fifth aspect of the present invention, tantalum or aluminum used to form the test terminal, the test wiring line, and the fixed-potential wiring line is also used in the formation of the display portion. Thus, the wiring lines can be formed simultaneously with a display portion formation process. Hence, the manufacturing process of the display panel can be simplified.

According to the sixth aspect of the present invention, at least one of electronic components including a chip capacitor, a chip resistor, and a chip coil is further mounted on the overhanging portion. Thus, a circuit board on which these components are conventionally mounted can be further miniaturized.

According to the seventh aspect of the present invention, by incorporating a display panel described in the first to sixth into a liquid crystal display device, the liquid crystal display device can provide the same effects as those described above.

### BRIEF DESCRIPTION OF THE DRAWINGS

FIG. 1 is a schematic plan view showing a configuration of a liquid crystal panel according to an embodiment of the present invention.

FIG. 2 is a plan view showing a schematic configuration of a test terminal in the embodiment.

FIG. 3 is a plan view showing a schematic configuration of a test terminal which is a variant of the embodiment.

FIG. 4 is a schematic plan view of a conventional liquid crystal panel before mounting an FPC board, which is used in a liquid crystal display device.

FIG. 5 is a schematic plan view of the conventional liquid crystal panel after mounting an FPC board, which is used in a liquid crystal display device.

FIG. 6A is a diagram showing a part of a procedure for bending the FPC board connected to an overhanging portion of a glass substrate.

FIG. 6B is a diagram showing a part of the procedure for bending the FPC board connected to the overhanging portion of the glass substrate.

FIG. 6C is a diagram showing a part of the procedure for bending the FPC board connected to the overhanging portion of the glass substrate.

### MODE FOR CARRYING OUT THE INVENTION

<1. Configuration of a Liquid Crystal Display Device>

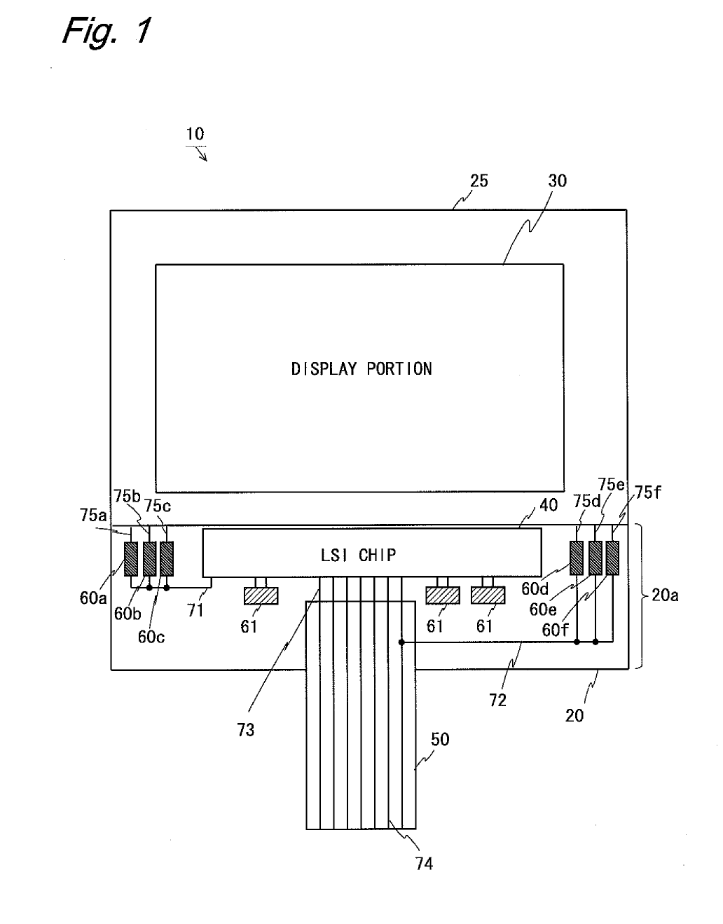

FIG. 1 is a schematic plan view showing a configuration of a liquid crystal panel 10 according to an embodiment of the present invention. The liquid crystal panel 10 includes, as shown in FIG. 1, two glass substrates 20 and 25 disposed to face each other, an LSI chip 40, and an FPC board 50.

A liquid crystal (not shown) is sealed in space sandwiched between the two glass substrates 20 and 25 by a sealing material (not shown). The LSI chip 40 is a bare chip (a chip before packaging) that has circuit patterns formed on a surface of a silicon substrate using a fine patterning technique so as to have the functions of a gate driver, a source driver, and a DC/DC converter, and that has bump electrodes with a height of about 15 μm formed as connection terminals for connecting the circuit patterns to an external source.

In the LSI chip 40, the bump electrodes formed on a surface of the LSI chip 40 are connected to one ends of FPC board connection pads 73 formed in an overhanging portion 20a (and wiring lines in a display portion, depending on the case), using the aforementioned ACF by a COG (Chip On Glass) method. In addition, wiring lines 74 formed on a base film of the FPC board 50 are also connected to the other ends of the FPC board connection pads 73 using the ACF. Since the wiring lines 74 of the FPC board 50 and the input terminals of the LSI chip 40 are thus connected through the FPC board connection pads 73, signals such as a video signal and a clock signal, a reference voltage, etc., provided to each wiring line 74 of the FPC board 50 from an external source are provided to a corresponding input terminal of the LSI chip 40.

The FPC board 50 is a board having the plurality of wiring lines 74 made of a copper foil with a thickness of 12 to 50 μm and formed on one side of a base film made of a flexible insulating film with a thickness of 12 to 50 μm, and can be freely bent. Note that, since the wiring lines do not include conventionally required wiring lines which are provided for six test terminals including a test terminal 81a, the width of the FPC board 50 is smaller than that of conventional ones. This point will be described in detail later.

Capacitors 61 are stabilizing capacitors used to remove noise superimposed on voltage generated in the LSI chip 40, to prevent a malfunction of the LSI chip 40 caused by noise; bypass capacitors used to remove noise superimposed on a video signal, a clock signal, a reference voltage, etc., provided from an external source through the FPC board 50, to prevent a malfunction of the LSI chip 40 caused by noise; or boost capacitors used to boost voltage together with a boost circuit (charge pump circuit) included in the LSI chip 40. Note that although in FIG. 1 the terminals of these capacitors are all connected to the terminals of the LSI chip 40, one terminal of each of the stabilizing capacitors and the bypass capacitors may be connected to a ground wire 72. For example, in a 2-inch QVGA (Quarter Video Graphics Array) liquid crystal panel, each of the capacitors 61 is a ceramic chip capacitor with a capacitance of 1 to 2.2 μF, a withstanding voltage of 6.3 to 16 V, and a size of 1.0 mm×0.5 mm. About 10 to 20 capacitors 61 in total are mounted on the overhanging portion 20a. As described previously, since these capacitors 61 are conventionally mounted on the FPC board, by mounting the capacitors 61 on the overhanging portion 20a, the FPC board can be further miniaturized.

An LSI ground wire 71 and the ground wire 72 are formed of a tantalum or aluminum thin film. Since the overhanging portion 20a has enough free space to form therein the LSI ground wire 71 and the ground wire 72, the widths of the LSI ground wire 71 and the ground wire 72 can be widened to the extent that their wiring resistances do not cause any problems. In addition, since, at the same time as when the FPC board 50 is connected to the overhanging portion 20a using the above-described ACF, the ground wire 72 is connected, using the ACF, to one of the wiring lines 74 of the FPC board 50 to which a ground potential is provided, the potential of the ground wire 72 is fixed to the ground potential. In addition, since the LSI ground wire 71 is connected to a GND terminal of the LSI chip 40, the potential of the LSI ground wire 71 is fixed to the ground potential, as well.

Note that, since the LSI ground wire 71 can be formed to be shorter in length than the ground wire 72, it can be said that forming all ground wires (or fixed-potential wiring lines) by LSI ground wires 71 is desirable in terms of no necessity to route wiring lines. However, considering the relationship with the disposition locations of other electronic components, a configuration in which different ground wires are appropriately disposed may be desirable in some cases. Therefore, in the present embodiment, taking into account this point, the LSI ground wire 71 and the ground wire 72 are provided.

Jumper resistors 60a to 60f are resistors with a substantially zero resistance, and one ends thereof are respectively connected to corresponding test wiring lines 75a to 75f of the liquid crystal panel 10. In addition, the other ends of the jumper resistors 60a to 60c are connected to the LSI ground wire 71, and the other ends of the jumper resistors 60d to 60f are connected to the ground wire 72. Therefore, in this state, since the test wiring lines 75a to 75f of the liquid crystal panel 10 are grounded, transistors (included in a test circuit) in the liquid crystal panel 10 can be turned off or a floating state can be avoided. Although, in this state, a test cannot be performed by inputting and outputting test signals to/from the test wiring lines 75a to 75f, a test can be performed before mounting the jumper resistors 60a to 60f. In order that such a test can be performed, test terminals which are connected to the jumper resistors 60a to 60f are provided. This configuration will be described in detail later. Note that the above-described test circuit does not need to be included in the liquid crystal panel 10 and may be included in, for example, the overhanging portion 20a. Note also that, instead of or together with the above-described transistors, for example, semiconductor elements such as PN junction diodes may be included.

An ACF used herein for such connections is obtained in a manner such that fine conductive particles are mixed in a thermosetting resin such as an epoxy-based resin and the mixture is formed in a film form. By applying predetermined pressure to a part of this ACF for a predetermined period of time while heating it to a predetermined temperature, conductive particles dispersed in the ACF overlap each other while coming into contact with each other, thereby forming conductive paths. At this time, conductive particles included in a portion of the ACF to which the pressure is not applied do not form a conductive path, and thus, insulating properties are maintained in a direction along a plane. When the ACF is heated while pressure is applied thereto, the thermosetting resin contained in the ACF is cured. Thus, even after completion of the application of pressure, the conductive paths formed in the ACF are maintained as they are. Note that, in place of an ACF, an anisotropic conductive paste in which conductive particles are mixed in a paste-like thermosetting resin may be used instead of the film form like an ACF.

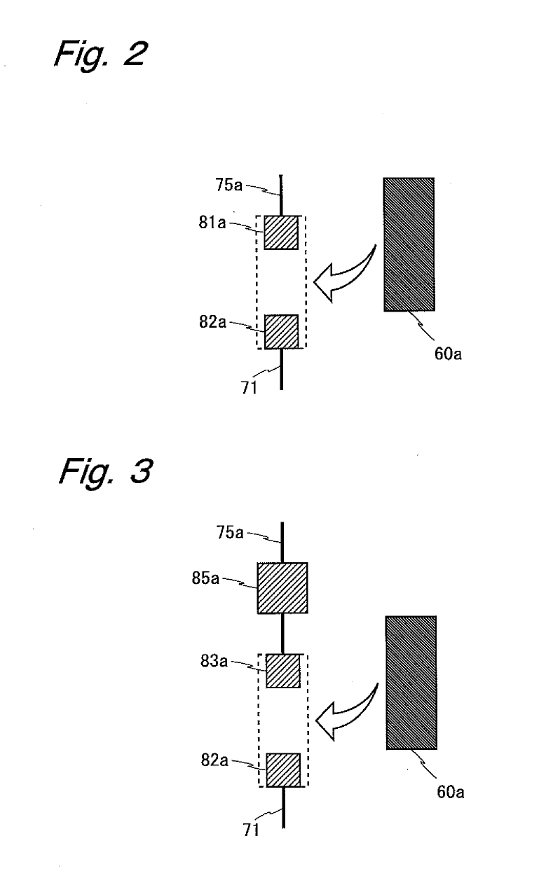

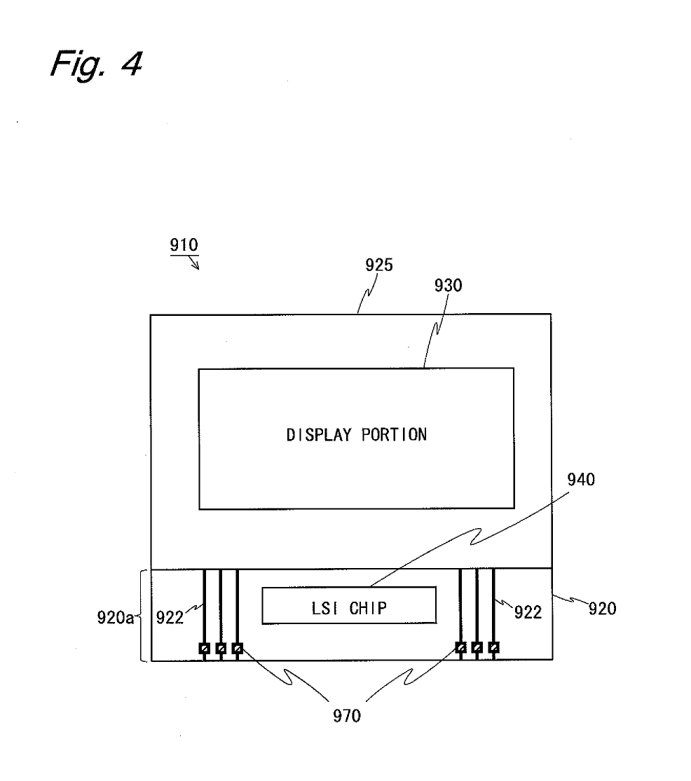

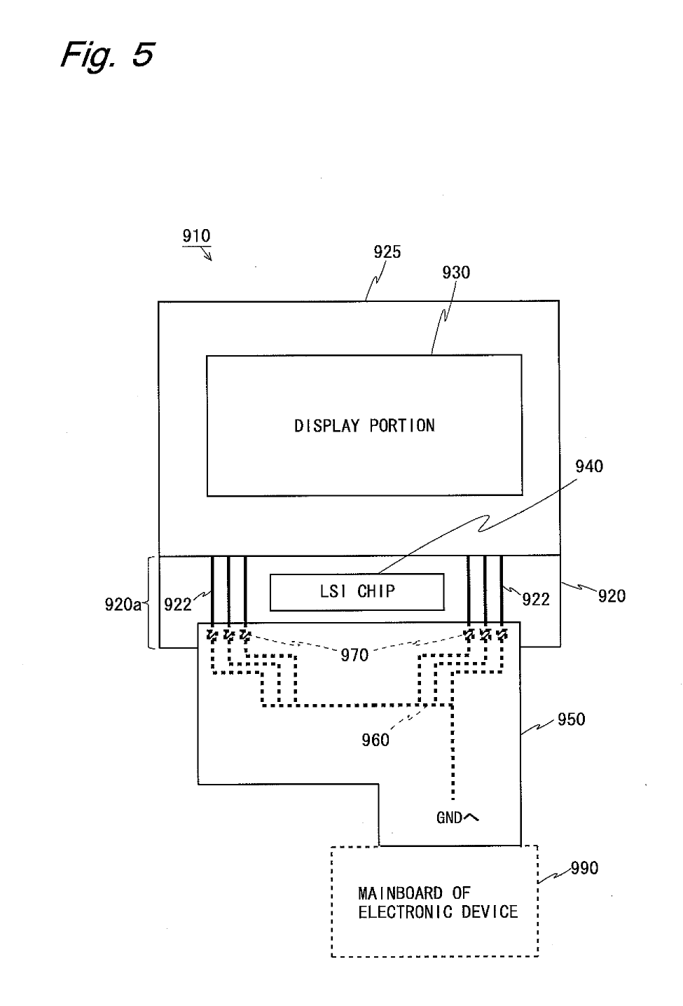

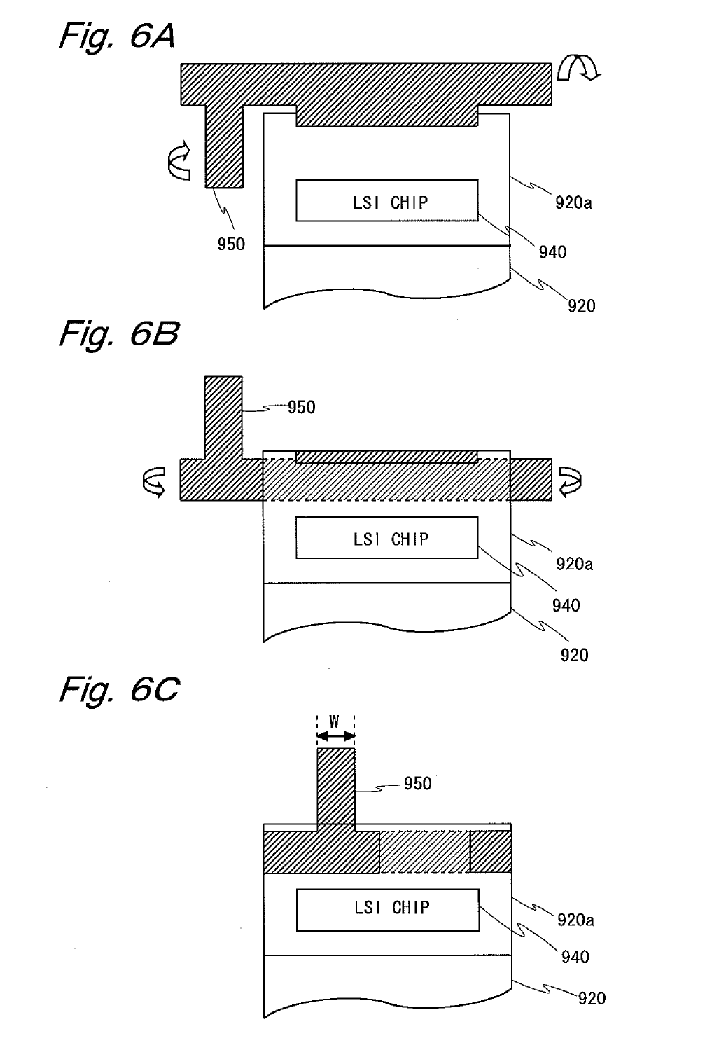

Note that the LSI ground wire 71, the ground wire 72, the test wiring lines 75a to 75f, the FPC board connection pads 73, and various terminals such as the test terminals are formed using tantalum or aluminum which is used in the formation of a display portion 30, and thus, are formed in the same manufacturing process as the display portion 30. Hence, the manufacturing process of the liquid crystal panel 10 can be simplified. Next, the test terminals connected to the jumper resistors 60a to 60f will be described with reference to FIGS. 2 and 3.

<2. Configuration of the Test Terminals>

FIG. 2 is a plan view showing a schematic configuration of a test terminal in the present embodiment, and FIG. 3 is a plan view showing a schematic configuration of a test terminal which is a variant of the present embodiment. A test terminal 81a shown in FIG. 2 is connected to the test wiring line 75a, and also serves as a connection terminal for mounting the jumper resistor 60a. Therefore, the test terminal 81a has substantially the same shape as a connection terminal 82a connected to the LSI ground wire 71. The jumper resistor 60a is connected to the test terminal 81a at one end thereof, and is connected to the connection terminal 82a at the other end thereof. Note that such a terminal structure and a connection relationship are also the same for the other jumper resistors 60b to 60f. Note also that these test terminals are formed using tantalum or aluminum which is used in the formation of the display portion 30, as with other wiring lines provided in the overhanging portion 20a, and thus, the manufacturing process of the liquid crystal panel 10 can be simplified.

Here, a test of the liquid crystal panel 10 is performed before mounting surface mounting components, such as the LSI 40 and the jumper resistors 60a to 60f, and the FPC board 50, and thus, the test terminal 81a is exposed on the surface during the test. Hence, there is no problem in performing the test. In addition, since the jumper resistors 60a to 60f are not mounted, the test terminals are, of course, not grounded and thus there is no problem in performing the test.

By a configuration in which the jumper resistors are provided in the overhanging portion 20a to ground the test terminals in the above-described manner, it becomes unnecessary to ground the test terminals on the FPC board 50. Thus, there is no need to provide, on the FPC board 50, wiring lines and connection terminals which are connected to the test terminals, respectively, and the numbers of which are equal to the number of the test terminals. In addition, by a configuration in which each test terminal also serves as a connection terminal for connecting a corresponding jumper resistor, the number of terminals can be reduced, enabling to simplify the configuration.

However, it is not necessarily need to allow a test terminal to also serve as a connection terminal for connecting a jumper resistor. As shown in FIG. 3, a test terminal and a connection terminal may be configured as different terminals. Specifically, a connection terminal 83a shown in FIG. 3 has exactly the same shape as the test terminal 81a shown in FIG. 2, but does not have a function as a test terminal. A test terminal 85a having a larger shape than the connection terminal 83a is newly provided. By thus providing the large test terminal 85a, it becomes easier to touch a test probe and thus the test is facilitated. In addition, apart from the size of the test terminal 85a, by providing the test terminal 85a separately from the connection terminal 83a, even if, for example, the test terminal 85a is chipped or damaged by a test probe, etc., a jumper resistor can be mounted without any problems. Thus, the test terminal 85a may be smaller than the connection terminal 83a.

<3. Effects>

According to a configuration in which jumper resistors are provided in the above-described manner, jumper components can be mounted after the test of the display portion 30, and thus, there is no need to ground test terminals by providing wiring lines, the number of which corresponds to the number of the test terminals, on the FPC board 50. Therefore, the width of the FPC board 50 can be reduced without bending the FPC board 50 connected to the overhanging portion 20a, and fixing the bent FPC board 50 by a tape. Hence, costs such as the material cost and processing cost of the FPC board 50 can be reduced. In addition, since the process of bending the FPC board 50 and fixing the FPC board 50 by a tape is unnecessary, mounting cost can be reduced. Furthermore, the influence of EMI is reduced and thus the operation of the LSI chip 40 can be stabilized.

<4. Variants>

In the liquid crystal panel 10 of the above-described embodiment, the test terminals connected to the test wiring lines 75a to 75f are connected to the LSI ground wire 71 or the ground wire 72 by the jumper resistors 60a to 60f, but may be connected to any other GND (ground) wire or may be connected to a VSS (low voltage) wire which is not shown. Alternatively, when the test terminals are connected to a predetermined fixed-potential wiring line having a fixed potential, at least the test terminals are not placed in an undefined potential, floating state and thus it is desirable. Note that, for the fixed-potential wiring line, as in the above-described embodiment, two fixed-potential wiring lines (i.e., the LSI ground wire 71 and the ground wire 72) may be provided, but a single fixed-potential wiring line may be provided, or a plurality of or a plurality of types of fixed-potential wiring lines may be provided. Note, however, that at least one of the fixed-potential wiring lines needs to be formed in the overhanging portion 20a. This is because if all of the fixed-potential wiring lines are formed on the FPC board 50, then jumper resistors are not necessary in the first place.

Although the jumper resistors 60a to 60f in the above-described embodiment have a substantially zero resistance, since it is only necessary that the potentials of the test terminals be fixed to the ground potential (or any other constant potential), the jumper resistors 60a to 60f do not necessarily need to have a substantially zero resistance and may have a relatively low resistance. In other words, a jumper component can be any as long as the jumper component can electrically connect (typically, short-circuit between) two points.

Although, in the liquid crystal panel 10 of the above-described embodiment, the gate driver, the source driver, and the DC/DC converter are all included in the LSI chip 40, all or any of them may be a monolithic-type integrated circuit which is formed, together with the display portion, in a region of the glass substrate 20 covered with the glass substrate 25 that is adjacent to the display portion 30, using a thin film of Continuous Grain silicon (CG silicon), amorphous silicon, polysilicon, or the like. Note that, when these integrated circuits are of the monolithic type, an LSI chip is not mounted on the overhanging portion 20a of the liquid crystal panel 10.

In the liquid crystal panel 10 of the above-described embodiment, the FPC board 50, which is a flexible board using a thin, flexible material as a base film, is secured to the overhanging portion 20a using an ACF. However, instead of the FPC board 50, a rigid board using a substrate with poor flexibility may be used. In this case, a B to B (Board to Board) connector is mounted on the overhanging portion 20a of the glass substrate 20 by an ACF. Output-side terminals of the B to B connector are respectively connected to connector wiring lines connected to input-side terminals of the LSI chip 40, and a rigid board is inserted into the input side. By doing so, the rigid board can be placed on or removed from the B to B connector again and again. In this manner, a circuit board such as an FPC board or a rigid board is connected to the overhanging portion 20a.

Although in the liquid crystal panel 10 of the above-described embodiment the electronic components mounted on the overhanging portion 20a are described as chip capacitors, the electronic components mounted on the overhanging portion 20a are not limited to chip capacitors, and may be other passive components such as chip resistors and chip coils, and furthermore may be active components such as light-emitting diodes (LEDs). By doing so, the FPC board can be further miniaturized. In addition, the chip capacitors are not limited to ceramic chip capacitors and may be tantalum chip capacitors, niobium oxide chip capacitors, etc. Note that light-emitting diodes mounted on the overhanging portion 20a are used as, for example, a backlight of the liquid crystal panel 10. Note also that although the liquid crystal panel 10 uses the glass substrate 20, an insulating substrate such as a transparent plastic substrate may be used.

Although in the above-described embodiment the liquid crystal panel 10 which is used in a liquid crystal display device is described, the present invention can be applied not only to liquid crystal panels, but also similarly to various types of display panels including organic or inorganic Electro Luminescence (EL) panels, Plasma Display Panels (PDPs), Vacuum Fluorescent Display (VFD) panels, and electronic papers.

### INDUSTRIAL APPLICABILITY

The present invention is applied to display panels, e.g., liquid crystal panels, and is suitably used for display panels having a circuit board, such as an FPC board, for providing a video signal, a clock signal, etc., from an external source.

### DESCRIPTION OF REFERENCE NUMERALS

10: Liquid Crystal Panel
20 and 25: Glass Substrate
20a: Overhanging Portion
30: Display Portion
40: LSI Chip
50: FPC Board
60a to 60f: Jumper Resistor
61: Capacitor
71: LSI Ground Wire
72: Ground Wire
73: FPC Board Connection Pad
74: Wiring Line of FPC Board
75a to 75f: Test Wiring Line
81a and 85a: Test Terminal
82a and 83a: Connection Terminal

1. A display panel that displays an image based on a video signal provided from an external source, the display panel comprising:
an insulating substrate having an overhanging portion;
a display portion formed on the insulating substrate and displaying the image;
a test terminal for inputting or outputting a test signal provided from or to the outside to perform a test on the display portion;
a test wiring line connecting the test terminal to the display portion;
a fixed-potential wiring line formed in the overhanging portion and providing a predetermined fixed potential;
a jumper component mounted on the overhanging portion and connecting the test wiring line to the fixed-potential wiring line;
an integrated circuit that drives the display portion based on the video signal; and
a circuit board having a wiring line layer and being connected to the insulating substrate by connecting the wiring line layer to a wiring line formed on the insulating substrate, the wiring line layer supplying a signal provided from an external source, to the integrated circuit.

2. The display panel according to claim 1, wherein
the jumper component is connected to the test terminal at one end thereof, and is connected to a connection terminal connected to the fixed-potential wiring line at an other end thereof.

3. The display panel according to claim 1, wherein
the jumper component is a resistor with a near zero resistance.

4. The display panel according to claim 1, wherein
at least one fixed-potential wiring line is connected to the integrated circuit, thereby providing the fixed potential.

5. The display panel according to claim 1, wherein
the test terminal, the test wiring line, and the fixed-potential wiring line are formed of tantalum or aluminum.

6. The display panel according to claim 1, further comprising at least one of electronic components mounted on the overhanging portion, the electronic components including a chip capacitor, a chip resistor, and a chip coil.

7. A liquid crystal display device comprising a display panel according to claim 1.
